(19) United States
(12) Patent Application Publication
(10) Pub. No.: US 2011/0037443 A1
(43) Pub. Date: Feb. 17, 2011

(54) PARALLEL CONNECTED PFC CONVERTER

(75) Inventors: Ta-Yung Yang, Milpitas, CA (US); Ming-Hsuan Lee, Taipei County (TW); Jian Chang, Taipei County (TW); Shih-Jen Yang, Taipei County (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: SYSTEM GENERAL CORPORATION, Taipei County (TW)

(21) Appl. No.: 12/718,049

(22) Filed: Mar. 5, 2010

Related U.S. Application Data
(60) Provisional application No. 61/274,296, filed on Aug. 14, 2009.

(51) Int. Cl. G05F 1/70

(52) U.S. Cl. 323/207

(57) ABSTRACT

A parallel PFC converter comprises a first PFC circuit, a second PFC circuit, and a voltage divider. The second PFC circuit is connected in parallel with the first PFC circuit for generating an output voltage of the parallel PFC converter. The voltage divider is coupled to receive the output voltage for generating a first feedback signal and a second feedback signal. The first feedback signal is higher than the second feedback signal. The first PFC circuit and the second PFC circuit respectively comprises a first switching control circuit and a second switching control circuit for regulating the output voltage. It is an object of the present invention to reduce the power loss for improving the efficiency of the PFC converter.

### CROSS REFERENCE TO RELATED APPLICATIONS

The present application claims the benefit of U.S. provisional application entitled “Parallel Connected PFC Converter”, Ser. No. 61/274,296, filed Aug. 14, 2009.

### BACKGROUND OF THE INVENTION

1. Field of the Invention

The present invention relates generally to converters, and more particularly, to PFC converters.

2. Description of the Related Art

PFC (power factor correction) converters are utilized to improve the power factor of AC power. The purpose of the power factor correction is to control the waveform of an AC line input current as sinusoidal and maintain the waveform variation in phase with an AC line input voltage. Via a rectification bridge, a DC input voltage is obtained positive with respect to a ground reference of the PFC converter. Detailed skills of the PFC converter can be found in prior arts, such as U.S. Pat. No. 7,116,090 titled “Switching Control Circuit for Discontinuous Mode PFC Converters”. High current demand decreases the efficiency of the PFC converter. Referring to the following equation, the power loss P_{LOSS} of the PFC converter is exponentially proportional to its input current.

P_{LOSS}=I²×R (1)

where I is the input current of the PFC converter; R is the impedance of the switching devices, such as the resistance of the inductor and the transistor, etc.

Therefore, there is a need to reduce the power loss for improving the efficiency of the PFC converter.

### BRIEF SUMMARY OF THE INVENTION

A parallel PFC converter comprises a first PFC circuit, a second PFC circuit, a voltage divider, a first resistor and a second resistor. The first PFC circuit generates an output voltage at an output of the parallel PFC converter. The second PFC circuit is connected in parallel with the first PFC circuit for generating the output voltage. The voltage divider is coupled to receive the output voltage for generating a first feedback signal and a second feedback signal. The first feedback signal is provided to the first PFC circuit and the second feedback signal is provided to the second PFC circuit. The first feedback signal is higher than the second feedback signal. The first PFC circuit comprises a first switching control circuit to generate a first switching signal for regulating the output voltage. A maximum on-time of the first switching signal is limited to determine a maximum output power of the first PFC circuit. The first PFC circuit comprises a first maximum-on-time circuit to determine the maximum on-time of the first switching signal. The maximum on-time of the first switching signal is programmable. The first resistor is coupled to the first switching control circuit for programming the maximum on-time of the first switching signal. The first PFC circuit comprises a first current-limit circuit to limit a maximum switching current of said first PFC circuit. The second PFC circuit comprises a second switching control circuit to generate a second switching signal for regulating the output voltage. A maximum on-time of the second switching signal is limited to determine a maximum output power of the second PFC circuit.

The second PFC circuit comprises a second maximum-on-time circuit to determine the maximum on-time of the second switching signal. The second resistor is coupled to the second switching control circuit to program the maximum on-time of the second switching signal. The second PFC circuit comprises a second current-limit circuit to limit a maximum switching current of the second PFC circuit.

It is an object of the present invention to reduce the power loss for improving the efficiency of the PFC converter.

### BRIEF DESCRIPTION OF THE DRAWINGS

The invention can be more fully understood by reading the subsequent detailed description and examples with references made to the accompanying drawings, wherein:

FIG. 1 shows an exemplary embodiment of a parallel connected PFC converter according to the present invention;

FIG. 2 shows an exemplary embodiment of a PFC circuit according to the present invention;

FIG. 3 shows an exemplary embodiment of a switching control circuit according to the present invention;

FIG. 4 shows an exemplary embodiment of a delay circuit according to the present invention;

FIG. 5 shows an exemplary embodiment of a ramp generator according to the present invention; and

FIG. 6 shows an exemplary embodiment of a mixing circuit according to the present invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

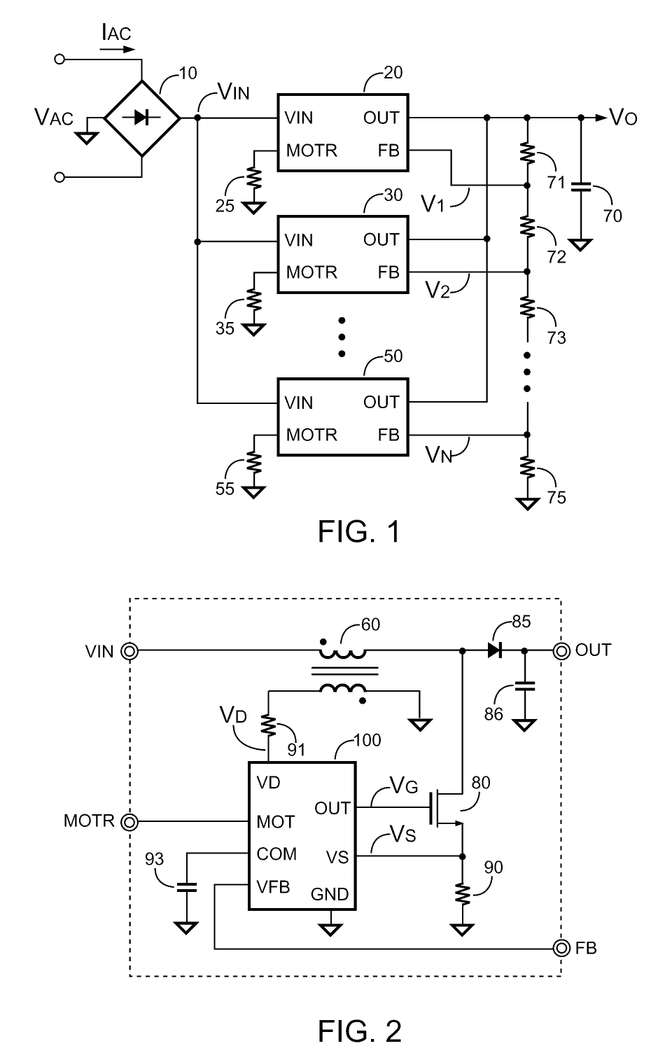

FIG. 1 shows an exemplary embodiment of a parallel connected PFC converter according to the present invention. Through the PFC conversion, an AC line input voltage V_{AC} is converted into a DC output voltage V_{O}. A bridge rectifier 10 is coupled to receive the AC line input voltage V_{AC} and an AC line input current I_{AC} to generate a rectified input voltage V_{IN}. A PFC circuit 20 generates the DC output voltage V_{O} at the output of the PFC converter. A capacitor 70 is connected to the output of the PFC converter for holding the DC output voltage V_{O}. A PFC circuit 30 and a PFC circuit 50 are connected with the first PFC circuit 20 in parallel to generate the DC output voltage V_{O}. A voltage divider comprises resistors 71, 72, 73 and 75 which are connected in series. The voltage divider receives the DC output voltage V_{O} for respectively generating feedback signals V₁, V₂ and V_{N}. The feedback signal V₁ is supplied to the PFC circuit 20 via a feedback terminal FB of the PFC circuit 20. The feedback signal V₂ is supplied to the PFC circuit 30 via a feedback terminal FB of the PFC circuit 30. The feedback signal V_{N} is supplied to the PFC circuit 50 via a feedback terminal FB of the PFC circuit 50. The feedback signal V₁ is higher than the feedback signal V₂. The feedback signal V₂ is higher than the feedback signal V_{N}. The PFC circuit 20 includes a first switching control circuit to generate a first switching signal for regulating the output of the PFC circuit 20. The maximum on-time of the first switching signal is limited by a maximum-on-time circuit of the PFC circuit 20 to determine a maximum output power of the PFC circuit 20. The maximum on-time of the first switching signal is programmable. A programming resistor 25 is coupled to the first switching control circuit of the PFC circuit 20 to program the maximum on-time of the first switching signal. The PFC circuit 20 further includes a current-limit circuit to determine a maximum switching current of the PFC circuit 20.

FIG. 2 shows an exemplary embodiment of a PFC circuit, such as 20, 30 and 50 of the present invention. A transistor 80 switches energy from the rectified input voltage V_{IN} of the PFC circuit via an inductor 60 and a rectifier 85 to generate the DC output voltage V_{O} across a capacitor 86. A switching control circuit 100 is coupled to generate a switching signal V_{G} at an output terminal OUT of the switching control circuit 100 to drive the transistor 80. A capacitor 93 is connected to a compensation terminal COM of the switching control circuit 100 to provide frequency compensation for a low frequency bandwidth which is below the line frequency. When the transistor 80 is turned on by the switching signal V_{G}, the inductor 60 will be charged via the transistor 80. A resistor 90 is connected to the transistor 80 for converting an inductor current flowing through the transistor 80 into a switching-current signal V_{S}. The switching-current signal V_{S} is then supplied to a sense terminal VS of the switching control circuit 100. The switching signal V_{G} is disabled to turn off the transistor 80 once the switching-current signal V_{S} exceeds a threshold voltage V_{R2}, which achieves cycle-by-cycle current limiting for the PFC circuit. While the transistor 80 is turned off by the switching signal V_{G}, energy stored in the inductor 60 will be released to generate the DC output voltage V_{O} at an output terminal OUT of the PFC circuit via the rectifier 85. As a discharge current of the inductor 60 declines to zero, a zero voltage will be detected at the auxiliary winding of the inductor 60. A detection terminal VD of the switching control circuit 100 connected to the auxiliary winding of the inductor 60 via a resistor 91 is used to detect the zero current state. A detection voltage V_{D} will be generated after the zero current state is detected.

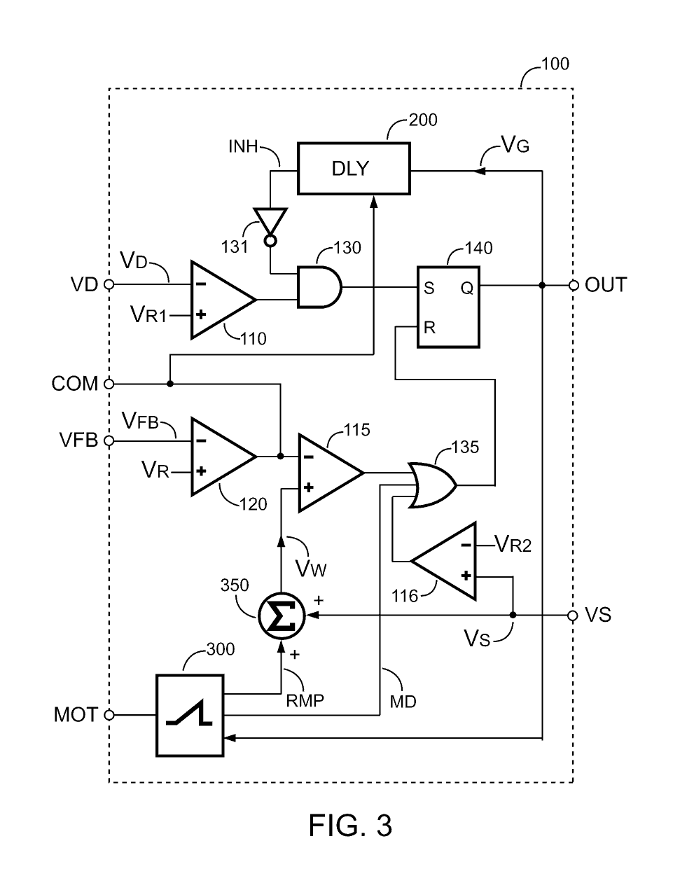

FIG. 3 shows an exemplary embodiment of the switching control circuit 100 according to the present invention. A ramp generator 300 produces a ramp signal RMP and a maximum-duty signal MD in response to the switching signal V_{G}. A terminal MOT of the switching control circuit 100 is connected to the ramp generator 300 to determine a slew rate of the ramp signal RMP and determine the maximum on-time of the switching signal V_{G}. The programming resistors 25, 35, 55 in FIG. 1 are respectively connected to terminals MOTR of the PFC circuits 20, 30, and 50 to determine their respective maximum on-times of their respective switching signals V_{G}. The terminals MOT of the switching control circuits of the PFC circuits 20, 30, and 50 are respectively connected to the terminals MOTR of the PFC circuits 20, 30, and 50.

The maximum on-time of the switching signal V_{G} also determines the minimum switching frequency of the switching signal V_{G}, which prevents the switching frequency from falling into the audio band. A positive terminal of an error amplifier 120 is supplied with a reference voltage V_{R}. A negative terminal of the error amplifier 120 is coupled to the output of the PFC converter via a feedback terminal VFB of the switching control circuit 100. The feedback terminal VFB of the switching control circuit 100 receives a feedback signal V_{FB}, such as the feedback signals V₁, V₂, and V_{N}. An output of the error amplifier 120 generates an error signal for regulating the DC output voltage V_{O} of the PFC converter. The error amplifier 120 is a trans-conductance error amplifier. The output of the error amplifier 120 is further connected to the compensation terminal COM of the switching control circuit 100. A mixing circuit 350 generates a mixing signal V_{W} in proportion to the ramp signal RMP and the switching-current signal V_{S}. A comparator 115 has a negative terminal connected to the output of the error amplifier 120. The comparator 115 further has a positive terminal supplied with the mixing signal V_{W}. An output of the comparator 115 generates a first reset signal which is supplied to a first input of an OR gate 135. A comparator 116 generates a second reset signal which is supplied to a second input of the OR gate 135. A third input of the OR gate 135 is supplied with the maximum-duty signal MD. The comparator 116 serves as the current-limit circuit which compares the threshold voltage V_{R2} and the switching-current signal V_{S} for achieving cycle-by-cycle current limiting. An output of the OR gate 135 is utilized to reset a flip-flip 140. The flip-flip 140 is utilized to generate the switching signal V_{G}. A comparator 110 compares the detection voltage V_{D} at the detection terminal VD and a threshold voltage V_{R1}. A detection signal is generated at an output of the comparator 110 when the detection voltage V_{D} is lower than the threshold voltage V_{R1}. The detection signal is supplied to a first input of an AND gate 130. The flip-flop 140 is enabled by the detection signal via the AND gate 130. Therefore, the switching signal V_{G} is enabled in response to the detection signal, and is disabled once the mixing signal V_{W} is higher than the error signal. Furthermore, a delay circuit (DLY) 200 is used for generating an inhibit signal INH when the switching signal V_{G} is disabled. Via an inverter 131, the inhibit signal INH is supplied to a second input of the AND gate 130. The inhibit signal INH provides a delay time to postpone enabling the switching signal V_{G} and therefore determines the maximum switching frequency of the switching signal V_{G}. In FIG. 3, the ramp generator 300, the OR gate 135, the flip-flop 140 and the respective programming resistor 25/35/55 connected to the terminal MOTR of the respective PFC circuit 20/30/50 form a maximum-on-time circuit to limit the maximum on-time of the switching signal V_{G}.

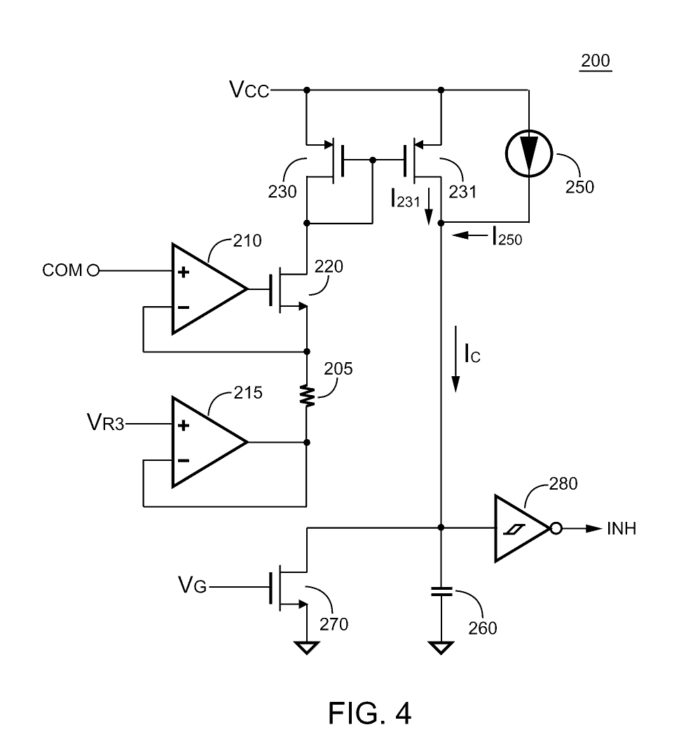

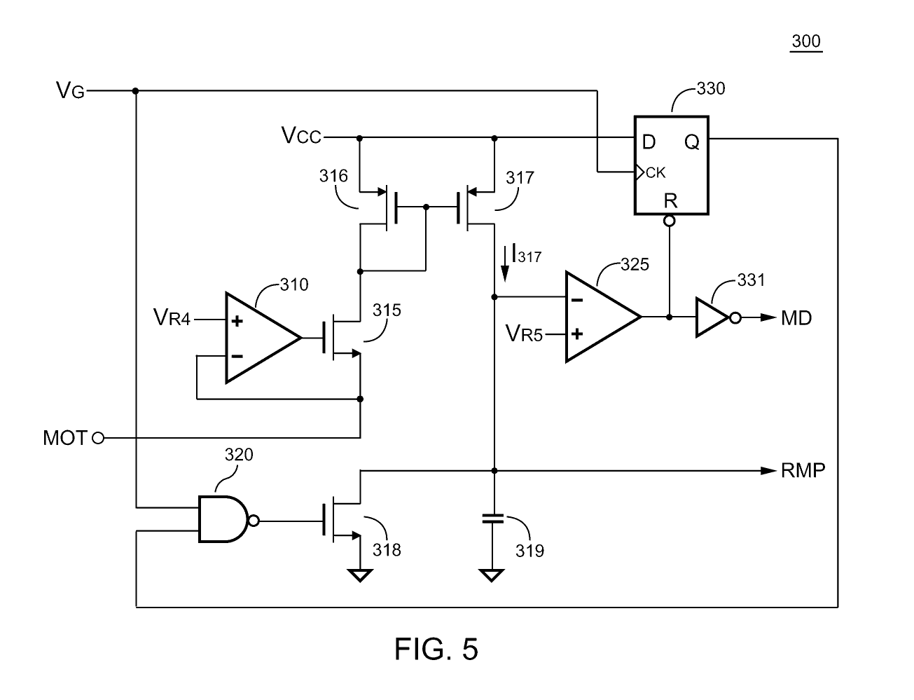

FIG. 4 shows an exemplary embodiment of the delay circuit 200 according to the present invention. Positive terminals of operational amplifiers 210 and 215 are respectively connected to the compensation terminal COM and supplied with a threshold voltage V_{R3}. A negative terminal and an output of the operational amplifier 215 are tied together. An output of the operational amplifier 210 is connected to a gate of a transistor 220. A source of the transistor 220 is connected to a negative terminal of the operational amplifier 210. A resistor 205 is connected between the source of the transistor 220 and the output of the operational amplifier 215. A transistor 230 and a transistor 231 form a current mirror. An input of the current mirror is connected to a drain of the transistor 220. A current source 250 is connected in parallel with the transistor 231. An output of the current mirror is connected to a drain of a transistor 270 and an input of an inverter 280. A gate of the transistor 270 is supplied with the switching signal V_{G}. A source of the transistor 270 is connected to a ground reference. A capacitor 260 is connected in parallel with the transistor 270. The operational amplifier 210 receives the error signal generated by the error amplifier 120 in FIG. 3. The operational amplifiers 210, 215, the resistor 205, and the transistors 220, 230, 231 are coupled to generate a current I₂₃₁. The current source 250 provides a current I₂₅₀. A charging current I_{C} is generated by summing the current I₂₃₁ and the current I₂₅₀. The current I₂₅₀ ensures a minimum magnitude of the charging current I_{C}. The current I₂₃₁ is generated in proportion to the error signal. The delay time generated by the delay circuit 200 is determined by the charging current I_{C} and a capacitance of the capacitor 260. The delay time is therefore increased in response to the decrease of the error signal. The error signal is decreased in proportion to the load decrement. The threshold voltage V_{R3} defines a light-load condition for the error signal. The capacitor 260 will be discharged as the switching signal V_{G} is enabled to turn on the transistor 270. The capacitor 260 will be charged as the switching signal V_{G} is disabled. The inverter 280 is connected to the capacitor 260 for generating the inhibit signal INH.

FIG. 5 shows an exemplary embodiment of the ramp generator 300 according to the present invention. An operational amplifier 310, transistors 315, 316, 317, and a programming resistor, such as the programming resistor 25 in FIG. 1, form a first voltage-to-current converter. The first voltage-to-current converter receives a reference voltage V_{R4} to generate a current I₃₁₇. The current I₃₁₇ is utilized to charge a capacitor 319 for generating the ramp signal RMP. The current I₃₁₇ determines the slew rate of the ramp signal RMP. A first input of a NAND gate 320 is supplied with the switching signal V_{G}. An output of the NAND gate 320 is connected to a gate of a transistor 318 to discharge the capacitor 319 when the switching signal V_{G} is disabled. Besides, the capacitor 319 will be discharged once the voltage across it is higher than a threshold voltage V_{R5}. This determines the maximum on-time of the switching signal V_{G}. An output of a comparator 325 is utilized to reset a flip-flop 330. An inverter 331 is driven by the output of the comparator 325 to generate the maximum-duty signal MD. The flip-flip 330 is set by the switching signal V_{G}. An output of the flip-flop 330 is connected to a second input of the NAND gate 320. Therefore, the current I₃₁₇, the capacitor 319, and the threshold voltage V_{R5} determine a maximum duration of the ramp signal RMP and further determine the maximum on-time of the switching signal V_{G}.

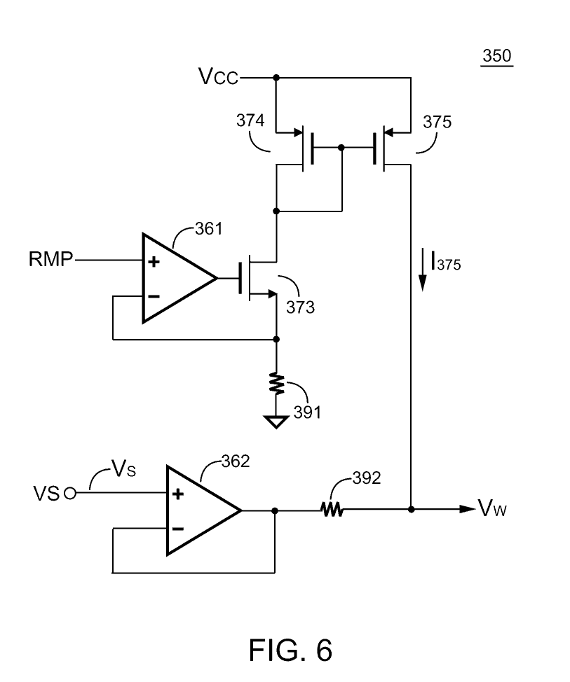

FIG. 6 shows an exemplary embodiment of the mixing circuit 350 according to the present invention. An operational amplifier 361, a resistor 391 and transistors 373, 374, 375 form a second voltage-to-current converter. The second voltage-to-current converter receives the ramp signal RMP to generate a current I₃₇₅. The switching-current signal V_{S} is supplied to a buffer amplifier 362. The current I₃₇₅ is supplied to a resistor 392 which is connected to an output of the buffer amplifier 362. The mixing signal V_{W} obtained from the resistor 392 is therefore in proportion to the sum of the ramp signal RMP and the switching-current signal V_{S}. The slew rate of the switching-current signal V_{S} is increased in response to the increment of the rectified input voltage V_{IN}. Accordingly, the slew rate of the mixing signal V_{W} is increased in response to the increment of the rectified input voltage V_{IN}. The on-time of the switching signal V_{G} is therefore increased in proportion to the decrement of the rectified input voltage V_{IN}. Modulating the on-time of the switching signal V_{G} helps to reduce the input current harmonic of the PFC converter.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A parallel PFC converter, comprising:
a first PFC circuit, generating an output voltage at an output of said parallel PFC converter;
a second PFC circuit, connected in parallel with said first PFC circuit for generating said output voltage; and
a voltage divider, coupled to receive said output voltage for generating a first feedback signal and a second feedback signal;
wherein said first feedback signal is provided to said first PFC circuit and said second feedback signal is provided to said second PFC circuit; and
wherein said first feedback signal is higher than said second feedback signal.

2. The parallel PFC converter as claimed in claim 1, wherein said first PFC circuit comprises a first switching control circuit to generate a first switching signal for regulating said output voltage, wherein a maximum on-time of said first switching signal is limited to determine a maximum output power of said first PFC circuit.

3. The parallel PFC converter as claimed in claim 2, wherein said first PFC circuit comprises a first maximum-on-time circuit to determine said maximum on-time of said first switching signal.

4. The parallel PFC converter as claimed in claim 2, wherein said maximum on-time of said first switching signal is programmable.

5. The parallel PFC converter as claimed in claim 2 further comprising a first resistor coupled to said first switching control circuit for programming said maximum on-time of said first switching signal.

6. The parallel PFC converter as claimed in claim 1, wherein said first PFC circuit comprises a first current-limit circuit to limit a maximum switching current of said first PFC circuit.

7. The parallel PFC converter as claimed in claim 1, wherein said second PFC circuit comprises a second switching control circuit to generate a second switching signal for regulating said output voltage, wherein a maximum on-time of said second switching signal is limited to determine a maximum output power of said second PFC circuit.

8. The parallel PFC converter as claimed in claim 7, wherein said second PFC circuit comprises a second maximum-on-time circuit to determine said maximum on-time of said second switching signal.

9. The parallel PFC converter as claimed in claim 7, further comprising a second resistor coupled to said second switching control circuit to program said maximum on-time of said second switching signal.

10. The parallel PFC converter as claimed in claim 1, wherein said second PFC circuit comprises a second current-limit circuit to limit a maximum switching
